(19) United States
(12) Patent Application Publication
(10) Pub. No.: US 2014/0229099 A1
(43) Pub. Date: Aug. 14, 2014

(54) LOCATION AWARE APPOINTMENT MANAGEMENT APPLICATION

(71) Applicant: Broadcom Corporation, Irvine, CA (US)

(72) Inventors: David Christopher Garrett, Tustin, CA (US); Brian Wacter, Ladera Ranch, CA (US); Hwa Chun Lee, Ladera Ranch, CA (US)

(21) Appl. No.: 13/906,237

(22) Filed: May 30, 2013

Related U.S. Application Data
(60) Provisional application No. 61/763,900, filed on Feb. 12, 2013.

(51) Int. Cl. H04W 4/02

(52) U.S. Cl. CPC H04W 4/028
USPC 701/465

(57) ABSTRACT

Various configurations and arrangements of various location aware appointment management applications are disclosed. Location aware appointment management applications can track the real-time location of the appointment participants, calculate the estimated time of arrival of the appointment participants based on a variety of factors including, for example, the participants' distance from the appointment location, speed of travel to the appointment location, real-time traffic conditions of the appointment participants route of travel to the appointment location, real-time weather conditions, profile information on the participants travel habits, the participants' mode of transportation, public transportation schedules and on time data, etc. Based on the calculated estimated time of arrival, the location aware appointment management application can determine whether the appointment participants are likely to be on time and, if not, the application can determine and suggest alternative appointment locations and/or times at which all participants could make the appointment on-time.

### TECHNICAL FIELD

The present disclosure relates to appointment management, including tracking the location of appointment participants.

### BACKGROUND

Mobile wireless communication devices such as cellular telephones, smartphones, personal digital assistants (PDAs), personal computers (PCs), tablet computers, laptop computers, etc. have evolved from large devices focused on a single application or use, such as analog voice communications, to comparatively smaller devices that are capable of and used for many different things such as digital voice communications and digital data communications, e.g., Short Message Service (SMS) for text messaging, email, packet switching for access to internets, gaming, Bluetooth®, Multimedia Messaging Service (MMS) and secure transaction capability. In addition to these capabilities, the mobile wireless communication devices of today have additional non-communication related capabilities, such as audio and/or video recording to provide an example, and software applications, such as a calendar and a contact list, to provide some examples.

Location based services (LBS) applications are emerging as a new type of value-added service provided by mobile communication networks. LBS applications are mobile services in which the mobile device user location information can be used to enable and/or support various applications and/or services such as enhanced 911 (E-911), location-based 411, location-based messaging and/or location-based friend finding services. A location of a mobile device may be determined in different ways such as using network-based technology, using terminal-based technology, and/or hybrid technology, which may be a combination of the former technologies. Many positioning technologies such as dead reckoning, Time of Arrival (TOA), Observed Time Difference of Arrival (OTDOA), Enhanced Observed Time Difference (E-OTD) as well as the Global navigation satellite-based systems (GNSS) such as Global Positioning System (GPS), Global Navigation Satellite System (GLONASS), Galileo, and/or Assisted-GNSS (A-GNSS), may be utilized to estimate the location (latitude and longitude) of the mobile device and convert it into a meaningful X, Y coordinate for Location-Based Services provided via wireless communication systems. This location information can then be used by either the network or mobile device user, or relayed to other devices and/or applications.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a block diagram of an exemplary communication system that can provide location based services and/or information to or about a plurality of mobile devices;

FIG. 2 illustrates a block diagram of an exemplary LBS enabled communication device;

FIG. 3 illustrates a flow chart of an exemplary process for calculating and conveying information derived and calculated by a location aware appointment management application from location data of several mobile devices provided by an LBS system;

FIG. 4 illustrates an exemplary mobile device display conveying information derived and calculated by a location aware appointment management application from location data of several mobile devices provided by an LBS system;

FIG. 5 illustrates an exemplary mobile device display conveying appointment information;

FIG. 6 illustrates an exemplary mobile device display conveying appointment attendee contact options as well as information derived and calculated by a location aware appointment management application;

FIG. 7 illustrates an exemplary mobile device display conveying appointment attendee travel information derived and calculated by a location aware appointment management application;

FIG. 8 illustrates another exemplary mobile device display conveying information derived and calculated by a location aware appointment management application from location data of several mobile devices provided by an LBS system;

FIG. 9 illustrates still another mobile device display conveying information derived and calculated by a location aware appointment management application from location data of several mobile devices provided by an LBS system as well as possible alternative appointment locations derived by a location aware appointment management application;

FIG. 10 illustrates an exemplary mobile device display conveying possible alternative appointment information derived by a location aware appointment management application;

FIG. 11 illustrates an exemplary mobile device display conveying detailed possible appointment location information; and

FIG. 12 illustrates still another mobile device display conveying information derived and calculated by a location aware appointment management application from location data of several mobile devices provided by an LBS system as well as possible alternative appointment locations derived by a location aware appointment management application.

### DETAILED DESCRIPTION OF THE DISCLOSURE

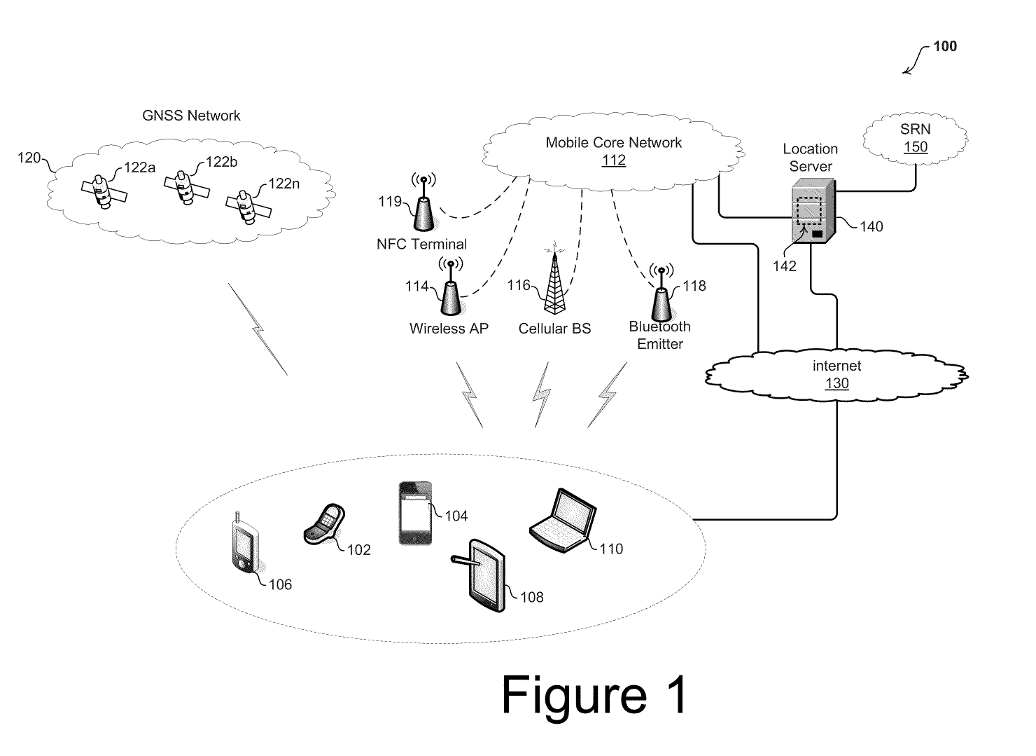

FIG. 1 is a block diagram illustrating an exemplary communication system that can provide location based services to a plurality of mobile devices. Referring to FIG. 1, there is shown a communication system 100 which includes a plurality of mobile devices, of which the mobile devices 102-110 are illustrated. One or more of the illustrated mobile devices 102-110 can include a location aware appointment management application or applications according to various embodiments described in more detailed herein. Exemplary mobile devices may include a cellular device 102, a Smartphone 104, a personal digital assistant (PDA) 106, a tablet computer 108, and/or a laptop computer 110. Also shown in the communication system 100 is a mobile core network 112, a wireless access point (AP) 114, a cellular base station (BS) 116, a Bluetooth® emitter 118, a Near Field Communication (NFC) terminal 119, a GNSS network 120, a plurality of GNSS satellites 122a-122n, an internet 130, a location server 140, and a satellite reference network (SRN) 150. One or more of the mobile core network 112, wireless AP 114, cellular BS 116, Bluetooth® emitter 118, NFC terminal 119, GNSS network 120, GNSS satellites 122a-122n, internet 130, location server 140, and/or satellite reference network (SRN) 150 can be used in assisting to determine the location of one or more of the mobile devices 102-110 for use in a location aware appointment management application and/or to provide communications links to the mobile devices 102-110 for allowing the mobile devices 102-110 to communicate as described in more detail herein with respect to a location aware appointment management application.

The wireless AP 114 may include suitable logic, circuitry, interfaces, and/or code that are operable to provide data services to communication devices, such as one or more of the mobile devices 102-110, in adherence with one or more wireless LAN (WLAN) standards such as, for example, IEEE 802.11, 802.11a, 802.11b, 802.11d, 802.11e, 802.11n, 802.11 ac, 802.11v, and/or 802.11u. The wireless AP 114 may communicate with the mobile core network 112 and/or the internet 130, via one or more links and/or associated devices for example. In this manner, the wireless AP 114 may provide network access to the mobile devices 102-110.

The cellular BS 116 may include suitable logic, circuitry, interfaces, and/or code that are operable to provide voice and/or data services to communication devices, such as one or more of the mobile devices 102-110, in adherence with one or more cellular communication standards. Exemplary cellular communication standards may include Global System for Mobile communications (GSM), General Packet Radio Services (GPRS), Universal Mobile Telecommunications System (UMTS), Enhanced Data rates for GSM Evolution (EDGE), Enhanced GPRS (EGPRS), and/or 3GPP Long Term Evolution (LTE). The cellular BS 116 may communicate with the mobile core network 112 and/or the internet 130, via one or more backhaul links and/or associated devices for example. In this manner, the cellular BS 116 may provide network access to the mobile devices 102-110.

The Bluetooth® emitter 118 may include suitable logic, circuitry, interfaces, and/or code that are operable to provide Bluetooth® based connectivity to communication devices, such as one or more of the mobile devices 102-110, in adherence with various Bluetooth® and/or Bluetooth® Low Energy (BLE) standards. The Bluetooth® emitter 118 may communicate with the mobile core network 112 and/or the internet 130, via one or more backhaul links and/or associated devices for example. In this manner, the Bluetooth® emitter 118 may provide network access to the mobile devices 102-110.

The NFC terminal 119 may include suitable logic, circuitry, interfaces, and/or code that can provide NFC-based connectivity to communication devices, such as one or more of the mobile devices 102-110, in adherence with various short range communication standards such as the Near Field Communications standards. The NFC terminal 119 may communicate with the mobile core network 112 and/or the internet 130, via one or more backhaul links and/or associated devices for example. In this manner, the NFC terminal 119 may provide network access to the mobile devices 102-110. One example implementation of an NFC terminal 119 is for use in a contactless payment system.

The mobile core network 112 may include suitable logic, circuitry, interfaces, and/or code that are operable to provide interfacing and/or connectivity servicing between access networks, which may be utilized by the mobile devices 102-110, and external data networks such as packet data networks (PDNs) and/or the internet 130. The mobile core network 112 may correspond to one or more service providers that provide, control, and/or manage network accessibility available via the mobile devices 102-110. In this regard, the mobile devices 102-110 may access the mobile core network 112 via the wireless AP 114, the cellular BS 116, the Bluetooth® emitter 118, and/or the NFC terminal 119. The mobile core network 112 may communicate various data services, which are provided by external data networks, to associated user devices such as, for example, the mobile devices 102-110. In an exemplary aspect of the disclosure, in instances where an LBS application is provided to a user device such as one or more of the mobile devices 102-110, the mobile core network 112 may be operable to communicate with the location server 140 to obtain location information that can be used by the LBS application.

Each of the mobile devices 102-110 may include suitable logic, circuitry, interfaces, and/or code for implementing various aspects of the embodiments disclosed herein. In this regard, each of the mobile devices 102-110 may be operable to communicate via a plurality of wired and/or wireless connections. Each of the mobile devices 102-110 may be operable, for example, to transmit to and/or receive signals from one or more of the wireless AP 114, the cellular BS 116, the Bluetooth® emitter 118, NFC terminal 119, the GNSS network 120, and/or the internet 130. Also, each of the mobile devices 102-110 may be operable to communicate with, and/or receive services provided by the internet 130 and/or the mobile core network 112. In this regard, the mobile devices 102-110 may be operable to utilize LBS applications, which can utilize the location server 140.

The GNSS network 120 may include suitable logic, circuitry, interfaces, and/or code that may provide navigation information to land-based devices via satellite links. In this regard, the GNSS network 120 may include, for example, the plurality of GNSS satellites 122a-122n, each of which is operable to provide satellite transmissions based on a global navigation satellite system (GNSS). Exemplary GNSS systems may include, for example, GPS, GLONASS, Galileo-based satellite system, Beidou and/or Compass systems. Accordingly, the GNSS network 120 may be operable to provide positioning information via downlink satellite links transmitted from one or more of the plurality of GNSS satellites 122a-122n to enable land-based devices, such as the mobile devices 102-110, to determine their locations. The plurality of GNSS satellites 122a-122n may directly provide positioning information and/or a land-based device may utilize satellite transmissions from different satellites to determine its location using, for example, triangulation based techniques.

The SRN 150 may include suitable logic, circuitry, interfaces, and/or code that are operable to collect and/or distribute data for GNSS satellites on a continuous basis. The SRN 150 may include a plurality of GNSS reference tracking stations located around the world to provide A-GNSS coverage all the time in both a home network and/or any visited network. In this regard, the SRN 150 may utilize satellite signals received from various GNSS constellations, such as, for example, the plurality of GNSS satellites 122a-122n of the GNSS network 120.

The location server 140 may include suitable logic, circuitry, interfaces, and/or code that are operable to provide and/or support location based services (LBS). In this regard, the location server 140 may be operable to store and/or process location related information pertaining to communication devices in the system 100, such as one or more of the mobile devices 102-110. The location information may be stored in a location reference database 142 in the location server 140. The location server 140 may be operable to collect and/or retrieve location information from communication devices. The location server 140 may also be operable to access additional and/or dedicated entities, such as the SRN 150 for example, to collect GNSS satellite data, and may be operable to utilize the collected GNSS satellite data to generate GNSS assistance data (A-GNSS data) including, for example, ephemeris data, long term orbit (LTO) data, reference positions and/or time information. The location server 140 may communicate the stored location data when requested to do so.

In operation, the location server 140 may be utilized to provide location based services (LBS) in the system 100. The location server 140 may maintain, for example, the location reference database 142, which may include elements corresponding to each of the mobile devices 102-110. The location server 140 may access the SRN 150 to collect GNSS satellite data, and may utilize the collected GNSS satellite data to generate GNSS assistance data (A-GNSS data) pertaining to the mobile devices 102-110. The location server 140 may also collect and/or retrieve location information directly from the mobile devices 102-110, and/or from other associated entities that interact with the mobile devices 102-110 in the system 100, such as, for example, the wireless AP 114, the cellular BS 116, the Bluetooth® emitter 118, and/or the NFC terminal 119. The retrieved location information may be stored in the location reference database 142 in the location server 140. The location server 140 may communicate the stored location data, e.g., when requested to do so. The location reference database 142, maintained in the location server 140, may be modified, refined, and/or updated using retrieved location information. The location information stored and/or maintained by the location server 140 may be utilized to augment and/or substitute for location information received and/or generated based on communication with the GNSS network 120, for example, when communication with the GNSS network 120 is disturbed.

The location data may also be locally generated, and/or maintained thereafter by devices and/or entities other than the location server 140. In this regard, location related data, which typically may be generated and/or maintained by the location server 140, may be locally generated, maintained, and/or used by the mobile devices 102-110, and/or by service providers thereof. Accordingly, devices and/or entities that typically may be serviced by the location server 140, such as the mobile devices 102-110, may also perform location related servicing locally. Furthermore, the locally generated and/or maintained location related data may be uploaded from the mobile devices 102-110, and/or service providers thereof, to the location server 140. Uploading the location related data may be performed periodically, on request, and/or based on configuration of the client devices or entities, and/or the location server 140 itself.

The location information stored and/or maintained in the location server 140 may be utilized to authenticate, for example, one or more of the mobile devices 102-110, users thereof, and/or locations thereof during operations performed by the mobile devices 102-110. In this regard, service providers, who may provide access servicing to the mobile devices 102-110, may contact the location server 140 to request that the location server 140 perform authentication procedures, and/or to obtain information necessary for performing the authentication procedures. The service providers may include, for example, cellular, Bluetooth®, WLAN, and/or NFC services providers. For example, a service provider of one of the mobile devices 102-110 may request authenticating the mobile device, its user, and location at a given instance. The location server 140 may then perform the necessary authentication procedures, which may be based on existing information in the location reference database 142, which is maintained by the location server 140. The location server 140 may also perform authentication procedures based on current information, which may be obtained by, for example, communicating with the mobile device, to verify its present location and/or connectivity status or parameters. In this regard, the location server 140 may communicate with the mobile device using IP packets that may be communicated via the internet 130, which may be transmitted to and/or received by the mobile device via its internet connectivity, and/or via its network access via the wireless AP 114, the cellular BS 116, the Bluetooth® emitter 118, and/or NFC terminal 119.

The internet 130 may include a system of interconnected networks and/or devices that enable exchange of information and/or data among a plurality of nodes, based on one or more networking standards, including, for example, Internet Protocol (IP). The internet 130 may enable, for example, connectivity among a plurality of private and public, academic, business, and/or government nodes and/or networks, wherein the physical connectivity may be provided via the Public Switched Telephone Network (PSTN), utilizing copper wires, fiber-optic cables, wireless interfaces, and/or other standards-based interfaces.

Various devices and/or user identification information may be utilized during network access and/or communications, which may be structured, allocated, and/or assigned based on the specific wired and/or wireless protocols that are used to facilitate any such network access and/or communication. For example, in GSM and/or WCDMA based networks, International Mobile Equipment Identity (IMEI) parameters may be utilized to uniquely identify mobiles devices, and these IMEI parameters may also be used and/or traced back to the mobile devices' users. Service providers may utilize the device and/or user identification information to track mobile devices and/or users. The service providers may track devices and/or users for various reasons, including, for example, billing or usage monitoring, and/or to help locate mobile devices, and/or their users, in cases of emergency and/or law enforcement purposes. Tracking of devices may also be used to provide authorized LBS and/or real-time device location information which can be utilized by location aware applications, such as exemplary embodiments of location aware appointment management applications according to the present disclosure, running on the mobile device or other devices and/or systems.

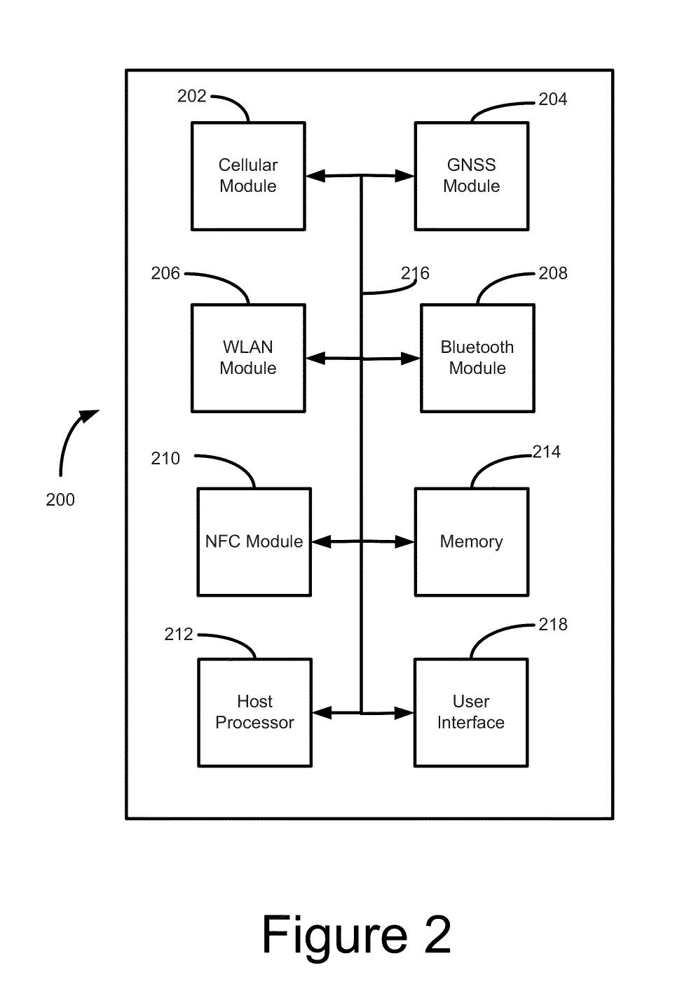

FIG. 2 illustrates a block diagram of an exemplary LBS enabled communication device 200 which includes a location aware appointment management application or applications according to various embodiments described in more detailed herein. The LBS enabled communication device 200 may communicate information over wired and/or wireless communication networks in accordance with various communication standards. The LBS enabled communication device 200 can represent a mobile device, such as a cellular phone or a smartphone, a mobile computing device, such as a tablet computer, a personal digital assistant, a watch, or a laptop computer, or any other electronic device that is capable of communicating information over communication networks that will be apparent to those skilled in the relevant arts. The LBS enabled communication device 200 can be implemented to be substantially similar to the mobile devices 102-110 shown in FIG. 1.

The LBS enabled communication device 200 can include a cellular module 202, a location based services module, such as GNSS module 204, a wireless local area network (WLAN) module 206, a Bluetooth® module 208, a Near Field Communication (NFC) module 210, a host processor 212, a memory 214, a user interface 218, or any combination thereof which are communicatively coupled to one another via a communication interface 216. The various modules can be used in assisting to determine the location of the LBS enabled communication device 200 for use in the location aware appointment management application and/or to provide communications links for allowing the LBS enabled communication device 200 to communicate with other mobile devices as described in more detail herein with respect to the location aware appointment management application. The host processor 212 and memory 214 can also be used for implementing and/or storing the location aware appointment management application and/or data for implementing some aspects of the location aware appointment management application. In some implementations, two or more of the modules included in the LBS enabled communication device 200 can be integrated to form a combination module. The LBS enabled communication device 200 need not include all of: the cellular module 202, the GNSS module 204, the WLAN module 206, the Bluetooth® module 208 and/or the NFC Module 210. Those skilled in the relevant art(s) will recognize that other configurations and arrangements of the LBS enabled communication device 200 may be possible. Additionally, those skilled in the relevant art(s) will also recognize that the cellular module 202, the GNSS module 204, the WLAN module 206, the Bluetooth® module 208, the NFC Module 210, the host processor 212, the memory 214, and the user interface 218 need not necessarily be communicatively coupled to one another via the communication interface 216. In some situations, those modules that are communicatively coupled to the communication interface 216 can independently communicate with other communication enabled devices without communication interface 216.

The cellular module 202 can provide wireless communication between the LBS enabled communication device 200 and a cellular BS, such as the cellular BS 116 shown in FIG. 1, over a cellular network in accordance with various cellular communication standards such as a Generation Partnership Project (3GPP) Long Term Evolution (LTE) communications standard, a fourth generation (4G) mobile communications standard, or a third generation (3G) mobile communications standard to provide some examples. The cellular module 202 may communicate with one or more transceivers, referred to as BSs or APs, within the cellular network to provide voice and/or data communications between the LBS enabled communication device 200 and another cellular capable device via a network, such as the mobile core network 112 shown in FIG. 1. The mobile core network may include a cellular telephone exchange that connects to a public telephone network or to another cellular telephone exchange within the mobile cellular network.

The GNSS module 204 can provide wireless communications between the LBS enabled communication device 200 and a GNSS Network, such as the GNSS Network 120 shown in FIG. 1, in accordance with various GNSS standards. The GNSS module 204 can receive various signals from various GNSS satellites, such as the satellites 122a-122n shown in FIG. 1, and to calculate a position of the LBS enabled communication device 200 based on the received signals. The GNSS module 204 may be implemented using a GNSS receiver which can use the GPS, GLONASS, Galileo and/or Beidou systems, among others, for calculating the position of the LBS enabled communication device 200.

The WLAN module 206 can provide wireless communications between the LBS enabled communication device 200 and a wireless AP, such as the wireless AP 114 shown in FIG. 1, over a wired communication network and/or to a wireless communication network in accordance with various networking protocols such a Wi-Fi™ communications standard. The WLAN module 206 can operate as a client to communicate with a wireless AP or as an AP itself to provide communications between other WLAN capable devices and a communication network. The WLAN module 206 may communicate with the mobile core network and/or the internet, through the wireless AP, via one or more links and/or associated devices for example. In this manner, the WLAN module 206 may provide network access to the LBS enabled communication device 200 via the wireless AP.

The Bluetooth® module 208 can provide wireless communications between the LBS enabled communication device 200 and a Bluetooth® emitter, such as the Bluetooth® emitter 116 shown in FIG. 1, over various Bluetooth® and/or Bluetooth® Low Energy (BLE) standards. The Bluetooth® module 208 can communicate with the mobile core network and/or the internet, via the Bluetooth® emitter, through one or more backhaul links and/or associated devices for example. In this manner, the Bluetooth® module 208 may provide network access to the LBS enabled communication device 200 via the Bluetooth® emitter.

The NFC Module 210 can provide short range wireless communications between the LBS enabled communication device 200 and another NFC device, such as the NFC terminal 119 shown in FIG. 1, over various short range communication standards such as the Near Field Communications standard. The NFC module 210 can communicate with the mobile core network and/or internet, via the NFC terminal through one or more backhaul links and/or associated devices for example. In this manner, the NFC module 210 may provide network access to the LBS enabled communication device 200 via the NFC terminal.

The host processor 212 can control overall operation and/or configuration of the LBS enabled communication device 200. The host processor 212 may receive information from, among other things, the user interface 216 and/or from other electrical devices or host devices that are coupled to the LBS enabled communication device 200. The host processor 210 can provide this information to the cellular module 202, the GNSS module 204, the WLAN module 206, the Bluetooth® module 208, the NFC module 210, the memory 214, and/or the user interface 218. Additionally, the host processor 212 can receive information from the cellular module 202, the GNSS module 204, the WLAN module 206, the Bluetooth® module 208, the NFC module 210, and/or the memory 214. The host processor 212 may provide this information to the user interface 218, to other electrical devices or host devices, and/or to the cellular module 202, the GNSS module 204, the WLAN module 206, the Bluetooth® module 208, the NFC Module 210, and/or the memory 214 via the communication interface 216. Further, the host processor 212 can execute one or more applications such as SMS for text messaging, electronic mailing, and/or audio and/or video recording, and/or software applications such as a calendar and/or a contact list to provide some examples. The host processor 212 can also execute a location aware appointment management application such as the exemplary embodiments described herein.

The user interface 218 can include a display, such as a touch-screen display, an alphanumeric keypad, a microphone, a mouse, a speaker, or another suitable input/output device capable of receiving user input and/or providing data to the user of the device. User provided information can be input into the user interface 218 such as by typing on the alphanumeric keypad, typing or selecting on the touch-screen display, selecting with the mouse, receiving verbal information and commands from the microphone, and/or through other methods of receiving user input. Information can be provided to the user through the user interface 218 such as by displaying the information on the touch-screen display, providing verbal information through the speaker, or through other methods of conveying and/or displaying information. The user interface 218 can interface with the host processor 212 to provide information to the host processor 212, such as via the communication interface 216 and to display information provided by the host processor 212 via the communication interface 216 to the user of the device. The user interface 216 can also receive and provide information to/from the cellular module 202, the GNSS module 204, the WLAN module 206, the Bluetooth® module 208, the NFC Module 210, and/or the memory 214.

The communication interface 216 can route various communications between the cellular module 202, the GNSS module 204, the WLAN module 206, the Bluetooth® module 208, the NFC Module 210, the host processor 212, the memory 214, and/or the user interface 218. These communications can include various digital signals, such as one or more commands and/or data, various analog signals, such as direct currents (DC) and/or voltages to provide some examples, or any combination thereof. The communication interface 216 can be implemented as a series of wired and/or wireless interconnections between the cellular module 202, the GNSS module 204, the WLAN module 206, the Bluetooth® module 208, the NFC Module 210, the host processor 212, the memory 214, and/or the user interface 218. The interconnections of the communication interface 216, as well as interconnections of other communication interfaces that are discussed below, can be arranged to form a parallel interface to carry communications between various modules of the LBS enabled communication device 200 in parallel using multiple conductors, a serial interface to carry communications between various modules of the LBS enabled communication device 200 using a single conductor, or any combination thereof. An LBS enabled communication device, such as the LBS enabled communication device 200, may include one or more integrated circuits that can be configured and arranged to form one or more modules, such as the cellular module 202, the GNSS module 204, the WLAN module 206, the Bluetooth® module 208, the NFC Module 210, the host processor 212, the memory 214, and/or the user interface 218 to provide some examples.

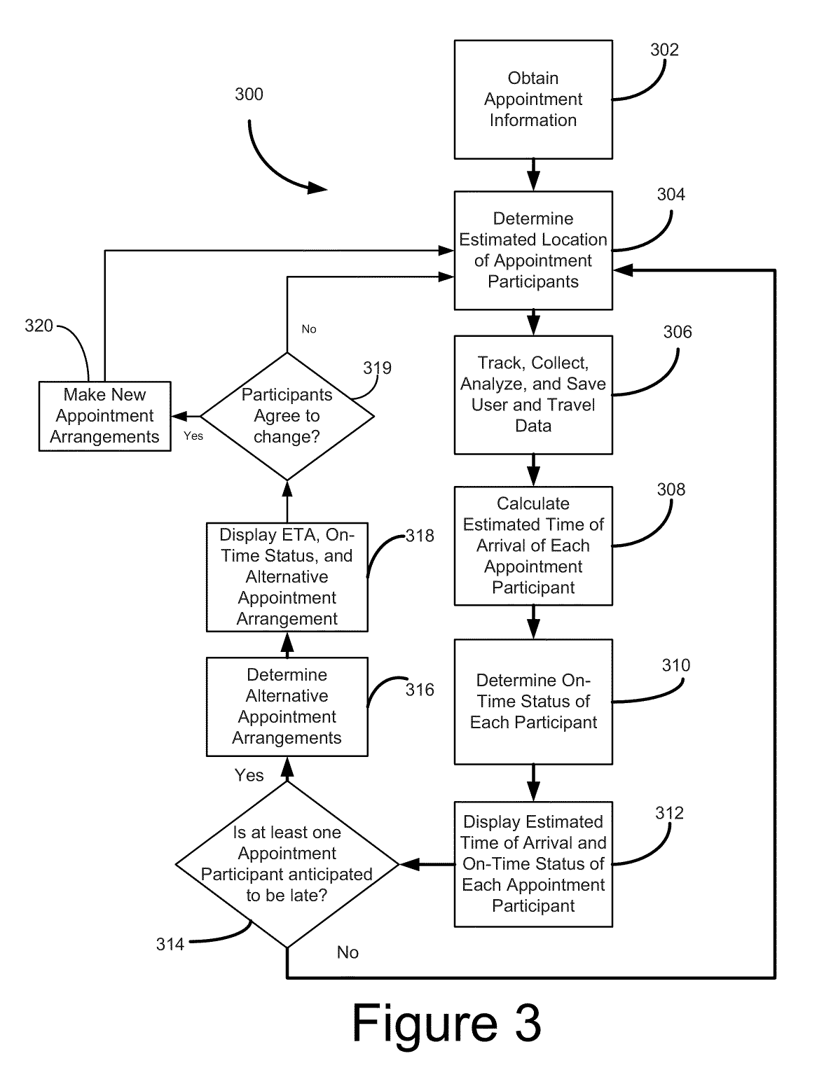

Exemplary embodiments of location aware appointment management applications can be implemented on an LBS enabled communication device, such as LBS enabled communication device 200. FIG. 3 is a flow chart illustrating an exemplary embodiment of a location aware appointment management application process and data flow 300. In some implementations, the location aware appointment management application obtains appointment information 302 such as the appointment date, time, and location as well as the appointment participants. The appointment information can be obtained in any number of ways. For example, the appointment information can be selected and/or extracted from a user's calendar application, an email, an SMS message, or another application or communication on the LBS enabled communication device or in communication with the location aware appointment management application. The appointment information can also be entered into the LBS enabled communication device or the location aware appointment management application through the user interface, such as by using an alphanumeric keypad, touch screen, and/or mouse, or by using a microphone to dictate the appointment information. An appointment in which a user is a requested or required attendee may also be made by someone other than the user. The location aware appointment management application may be distributed across multiple devices and/or may interface with other devices across communication networks to accept appointment information from other devices. The location aware appointment management application may interface with various social media sources or electronic invitation applications to accept appointment information. The LBS enabled communication device can accept appointment information using short range communication techniques such as Near Field Communication (NFC) and/or other short range communication methods.

The LBS enabled communication device and/or the location aware appointment management application may also be equipped with artificial intelligence or a form of behavioral observation intelligence. In this regard, the location aware appointment management application may observe patterns in the user's schedule and suggest predicted appointments based on the user's observed behavior. For example, the location aware appointment management application may observe that the user attends a weekly status meeting most every Wednesday at 10:00 am in the main board room at the user's office. Based on this observed behavior, the location aware appointment management application may automatically add or make a suggestion to the user to add an appointment into the application, as well as send an appointment attendance request to any other observed participants. Similarly, the location aware appointment management application may infer, based on observed behavior, that the user drops off his or her children at school almost every Monday, Tuesday, and Thursday and thus may automatically add or suggest to the user that an appointment be added for this activity.

In some implementations, the location aware appointment management application can determine the estimated location of the appointment participants 304. The estimated location of the appointment participants can be determined in any number of ways. For example, the estimated location of a mobile communications device used by the appointment participants can be determined as generally described above and this location can be assumed to be the appointment participant's location. The estimated location of the appointment participant's mobile device can be determined using location based services, for example, by utilizing a location based services module such as GNSS module 204 shown in FIG. 2. Network-based technology, terminal-based technology, and/or a hybrid of both network-based and terminal-based technologies can be used. Positioning technologies can include dead reckoning, TOA, OTDOA, E-OTD as well as Global navigation satellite-based systems (for example GNSS network 120 shown in FIG. 1) such as GPS, GLONASS, Galileo, and/or A-GNSS, among others. Triangulation between wireless APs and/or cellular BSs (for example Wireless AP 114 or Cellular BS 116 shown in FIG. 1) can be used with TOA, OTDOA, E-OTD, received signal strength and/or other methods to determine the estimated location of a mobile communication device. The estimated location of a mobile communication device can also be determined using the closest WLAN AP as an indication of location, RF fingerprinting, using the closest Bluetooth emitter as an indication of location, using connection to an NFC terminal as an indication of estimated location, or any number of other known methods for determining location. As generally described above, the estimated location information about a mobile device can be stored and/or retrieved from a location reference database (for example database 142 shown in FIG. 1) in a location server (for example location server 140 shown in FIG. 1). In one embodiment, the location aware appointment management application can determine and/or begin tracking the estimated location of appointment participants some predetermined amount of time before the scheduled appointment time.

Exemplary embodiments of the location aware appointment management application can track, collect, analyze, and/or save user specific information about each appointment participant and/or travel specific information about specific travel routes 306. The location aware appointment management application can track and record information about the appointment participant's travel habits in a predictive user profile. The location aware appointment management application can also track and record information about common travel routes in a predictive route profile. Information about the appointment participant's travel habits and/or travel route may also be input into the predictive user profile and/or the predictive route profile through a user interface such as the ones described above. The inputted information can also be updated over time based on observations made by the location aware appointment management application.

The predictive user profile information can generally include information about a particular appointment participant such as, among other things, the mode of transportation the appointment participant typically uses (e.g., automobile, public transportation, walking, etc.), the route an appointment participant typically takes between two points (such as between his/her home and office), etc. If the appointment participant is known to be driving or deduced to be driving, the location aware appointment management application can observe and/or apply appointment participant driving habits information such as, for example, how fast or slow the appointment participant typically drives (does he/she typically drive at the speed limit, above the speed limit, below the speed limit, etc.), and/or whether the appointment participant exhibits a preference for highway driving, surface streets, toll roads, etc. and record the information in the predictive user profile. The predictive user profile information can also include an appointment participant's travel habits. For example, the appointment participant might follow a certain route every time he/she travels between two locations, such as, for example, home and the office. Furthermore, the route an appointment participant favors may vary based on the day of the week or on the time of day the appointment participant leaves a certain location. For example, the appointment participant might travel directly between home and the office on Monday, Wednesday, and Friday by one certain route and travel another route (such as a route in which the appointment participant drops off his/her children at school) on Tuesdays and Thursdays or the appointment participant may leave for work at 6:00 am on Mondays, Tuesdays, and Thursdays, but 8:00 am on Wednesdays and Fridays. The location aware appointment management application can track this information and record it in the predictive user profile for later use.

The location aware appointment management application can also observe and account for typical time-based stops based on, for example, time of day, location, route, other scheduled events on the appointment participant's calendar, etc. and record this information in the predictive user profile. For example, the location aware appointment management application may observe that if the appointment participant leaves home at 7:00 am, he/she typically stops to drop his/her children off at school. The location aware appointment management application may also observe that the appointment participant spends about 10 minutes stopped at the school on these occasions. As such, the location aware appointment management application may deduce that the appointment participant is likely dropping his/her children off at school on the way in to the office and, as such, may deduce that the appointment participant is likely to take a route from the appointment participant's home, past the children's school, and on to the office and that the appointment participant will spend 10 minutes stopped along the way to the office if the appointment participant leaves home at around 7:00 am. In another situation, the location aware appointment management application may observe that if the appointment participant leaves home at around 8:00 am, he/she typically stops at a coffee shop to pick up coffee. The location aware appointment management application may observe that the appointment participant spends 15 minutes at the coffee shop before resuming his/her drive to the office. As such, the location aware appointment management application may deduce that if the appointment participant leaves his/her home at around 8:00 am, he/she is likely to choose a route from the appointment participant's home, past the coffee shop, and on to the office and that the appointment participant will likely spend 15 minutes stopped at the coffee shop on the way to the office. The location aware appointment management application can observe when and where the appointment participant typically stops, e.g., to use a restroom, or for breakfast, or for dry cleaners, etc. and record this and other information in the predictive user profile for later use.

Additional information can be gathered by the appointment participant's LBS enabled communication device and the additional information can be recorded and accounted for in the predictive user profile. For example, the Bluetooth® module 208 can connect with the appointment participant's automobile diagnostic system to gather information about the automobile. This information can include how much fuel is in the automobile, an average rate of fuel consumption, the current rate of fuel consumption, whether the automobile is experiencing any operational problems, etc. This information can be used by the location aware appointment management application to determine if the appointment participant is likely to stop for fuel on the way to the scheduled appointment or experience some sort of operational problem which would delay the appointment participant's travel to the appointment. The Bluetooth® module 208 can also connect to the appointment participant's automobile GPS/routing system. In this way, the location aware appointment management application can obtain and/or deduce information about the route the appointment participant is likely to take to the appointment location by observing any possible programmed or suggested route being used by the automobile GPS/routing system.

If the appointment participant is known or deduced to be taking public transportation, information about appointment participant's travels may be observed, recoded and accounted for by the predictive user profile. For example, the typical mode of public transportation (such as bus, train, subway, boat, etc.), the public transportation based route, typical transfers between routes, typical appointment participant stops, etc. may all be observed recorded and accounted for by the location aware appointment management application and recorded in the predictive user profile. The location aware appointment management application can access real-time and historical time tables for the specific routes expected to be used by the appointment participant. Time based stops, similar to those described above with respect to driving, can be observed, recorded and accounted for. The location aware appointment management application can use gathered and observed information to determine if the appointment participant is likely to make transfers to other public transportation routes along the way and, if not, can determine which route the appointment participant is likely to take as an alternative. The historical on-time records of the public transportation routes can be recorded in the predictive user profile and/or accessed. The effects of weather, holidays, weekends, can be considered. The location aware appointment management application can observe, record, and/or determine if the appointment participant is likely to use multiple different modes of transportations, (i.e. part driving, part taking a train, part walking, etc.) and account for each different possible combination.

The location aware appointment management application can also consider whether the appointment participant is, or is likely, traveling by commercial airlines and, if so, the real-time and/or historical on-time performance of the known or determined flight being used by the appointment participant can be considered. The location aware appointment management application can also consider and/or determine whether the appointment participant is walking to the appointment (such as if the appointment participant is walking between office buildings on a company campus) and, if so, determine the most likely route and any factors which might affect the appointment participant's travel time to the appointment location.

The location aware appointment management application can also observe and account for other appointment attendee specific information such as whether the user is historically late for appointments, or whether the appointment participant has another appointment or meeting scheduled on his/her calendar which might indicate that he/she will be making a stop and be stopped for a period of time while on the way to the appointment location or that the appointment participant has an overlapping or conflicting appoint that prevents him/her from making the scheduled appointment or might make him/her late and record this information in the predictive user profile.

The predictive route profile can generally include information about a particular route of travel such as, among other things, historical traffic patterns, the effect of various weather conditions on traffic and/or travel times along the route, the effect holidays and/or weekends have on traffic, public transportation availability, and/or travel times along the route, historical on-time records of public transportation along the route, the effect of special events, such as the President being in town, or a Super Bowl parade, along or near the route, historical flight delays on certain commercial airline flights, etc. Information tracked, collected, and analyzed can be saved in the predictive route profile for later use by the location aware appointment management application when determining an estimated time of arrival of an appointment participant traveling on or near a route saved in the predictive route profile. The information saved in the predictive route profile can be used for various different appointment participants.

Exemplary embodiments of the location aware appointment management application can calculate the estimated time of arrival (ETA) of each appointment participant 308 based on a variety of information including the real-time information, such as, for example, the determined estimated location of each appointment participant, as well as appointment specific predictive information, such as from the predictive user profile and/or the predictive route profile. The appointment specific predictive information can include predictive information about the appointment participant and/or predictive information about the route of travel of the appointment participant. Information used in calculating the ETA of an appointment participant can include, but is not limited to, distance from appointment location, current rate of travel, anticipated rate of travel, whether the appointment participant is currently en route to the appointment location and/or, if en route, whether the appointment participant is making progress toward the appointment location or whether the appointment participant has stopped or is sidetracked, etc. The anticipated rate of travel can include information, such as the speed limits and current traffic conditions on the appointment participant's route, as well as the appointment specific predictive information about the appointment participant's travel habits and/or the appointment participant's travel route from the predictive user profile and/or the predictive route profile.

The location aware appointment management application can also be configured to analyze and use other available appointment specific predictive information to determine the estimated time of arrival of an appointment participant. For example, the location aware appointment management application could determine that the appointment participant had another appointment scheduled before the current appointment and determine where the prior appointment was scheduled to take place. If the location aware appointment management application determines that the appointment participant is still in the prior appointment location past the scheduled appointment end time, it could deduce that the appointment did or is running long and the location aware appointment management application can factor this information into the calculated ETA. Similarly, if the appointment participant's calendar indicates that he/she had a teleconference scheduled before the current appointment and the location aware appointment management application determines that the appointment participant is still on the phone and not moving, the location aware appointment management application may determine that the teleconference is running long and can factor this information into the calculated ETA. A partially or totally overlapping appointment on the appointment participant's calendar can also be considered when calculating the ETA of the appointment participant.

Exemplary embodiments of the location aware appointment management application can determine the on-time status of one or more appointment participants 310 based on the estimated time of arrival of the appointment participant and the scheduled appointment time. The on-time status of the appointment participant, as well as their estimated time of arrival and the appointment information can be displayed 312 on the user interface. If at least one of the tracked appointment participants is anticipated to be late for the appointment 314, the location aware appointment management application can determine alternative appointment arrangements 316 to which some or all participants could be on-time. The alternative appointment arrangements can then be displayed on the user interface along with the ETA and on-time status of the appointment participants 318. If the appointment participants agree to alternative appointment arrangements 319, the location aware appointment management application can make new appointment arrangements 320 by, for example, updating the appointment participant's calendars, making or rescheduling the appointment location, such as scheduling conference room use, or making a restaurant reservation. In either case, i.e. whether all participants are anticipated to be on-time or some are anticipated to be late, the location aware appointment management application can continually loop back to determining the estimated location of the appointment participants to update and track the previously tracked, collected, analyzed, determined and saved information 304. The location aware appointment management application can also be set to stop determining and displaying alternative appointment arrangements after the appointment participants decline to change the appointment arrangements a certain number of times.

When determining alternative appointment arrangements, the location aware appointment application can determine the new appointment arrangements to account for the anticipated late arriving participant(s) and/or to facilitate near simultaneous arrival of some or all appointment participants. These alternative appointment arrangements can include, for example, rescheduling the appointment time, determining an alternative appointment location, etc. Determining an alternative appointment location can include, for example, finding a new appointment location based on the estimated current location of some or all of the appointment participants. The specific type of establishment for the appointment can also be a factor. For example, the appointment participants may have shown a preference for meeting in, a coffee shop, a restaurant, a specific type of restaurant, a hotel, a particular hotel chain, etc., or the location aware appointment management application may look for convenient establishments of the type at which the current appointment was originally to take place. The availability of resources, such as restaurant reservation availability, conference room availability, video and/or audio equipment availability, computer equipment availability, demo equipment availability, etc. can also be considered.

Determining an alternative appointment time can also be based on a variety of factors. For example, the location aware appointment management application could access the appointment participants' calendars to determine a time when some or all of the appointment participants are available. The location aware appointment management application might determine, based on the appointment participants' calendars, that all or most of the appointment participants are going to be in the same general area at about the same time. This information could be used in suggesting an alternative appointment time. The availability of resources, such as described above with regard to alternative appointment locations, can also be a factor.

In addition or as an alternative to suggesting an alternative appointment time and/or location, the location aware appointment management application may suggest an alternative appointment type to accommodate all participants. For example, if all but one appointment participant is estimated to be on-time for the appointment, the location aware appointment management application may suggest keeping the currently scheduled appointment time and location and adding a call in number for the estimated late appointment participant. In this manner, the appointment participant who is estimated to be late may alternatively participate in part or all of a meeting associated with the appointment via teleconference. If more than one and/or many appointment participants are all estimated to be late, the location aware appointment management application may suggest changing a face-to-face appointment into a teleconference in order to accommodate the appointment participants. In this situation, the location aware appointment management application can arrange a conference call bridge for the appointment participants, update the appointment participants' calendars, and send the conference call bridge and teleconference information to the appointment participants.

Alternatively, or in addition to the above, the location aware appointment management application may determine that one or more of the appointment participants who are estimated to be late are at or near available video conference equipment and thus, the location aware appointment management application may suggest that these appointment participants attend the appointment via video conference. The location aware appointment management application can book the video conference equipment and set up the video conference. The location aware appointment management application may determine, based on the type of appointment scheduled, that an online meeting application, e.g. WebEx, may be an efficient way for some or all of the appointment participants to participate and as such, this alternative may also be suggested and arranged by the location aware appointment management application.

The location aware appointment management application may also determine that there are distinct groups of meeting participants in different locations and, as such, the location aware appointment management application may suggest two or more separate appointment locations, one to accommodate each group, with the suggestion that the two groups connect via teleconference or video conference. The location aware appointment management application can make all of the arrangements, e.g. book the appointment locations, arrange the teleconference/video conference equipment, book/arrange other needed resources, etc. As still another alternative, the location aware appointment management application may determine that the appointment could be efficiently broken out into separate appointments with two or more distinct groups of appointment participants. The location aware appointment management application may suggest the two or more separate appointments at separate times or at the same time. In some implementations, the groups of participants can be completely distinct between the divided meetings, while in others two or more of the divided meetings can include at least one common participant. Further, the divided meetings can occur in separate locations to accommodate the estimated current locations of the different groups or can be scheduled for the same location at different times, e.g., to make use of a necessary resource. The location aware appointment management application may also suggest a later, follow up appointment with members of the groups of appointment participants or with one or more representatives from the groups in order for the groups to report and coordinate. As with the other alternatives discussed above, the location aware appointment management application can make all of the arrangements of the appointments as well as any follow on appointments.

The location aware appointment management application can request that the appointment participants select one of the proposed new appointment locations, appointment times/dates, and/or a new appointment location and/or time/date. Once a new appointment location and/or date and time is selected, the location aware appointment management application can automatically make new appointment arrangements. These new appointment arrangements can include, for example, notifying all participants of the new appointment arrangements, updating appointment participants' calendars, updating route information on participants' navigation applications, cancelling old appointment reservations, making new appointment reservations, etc.

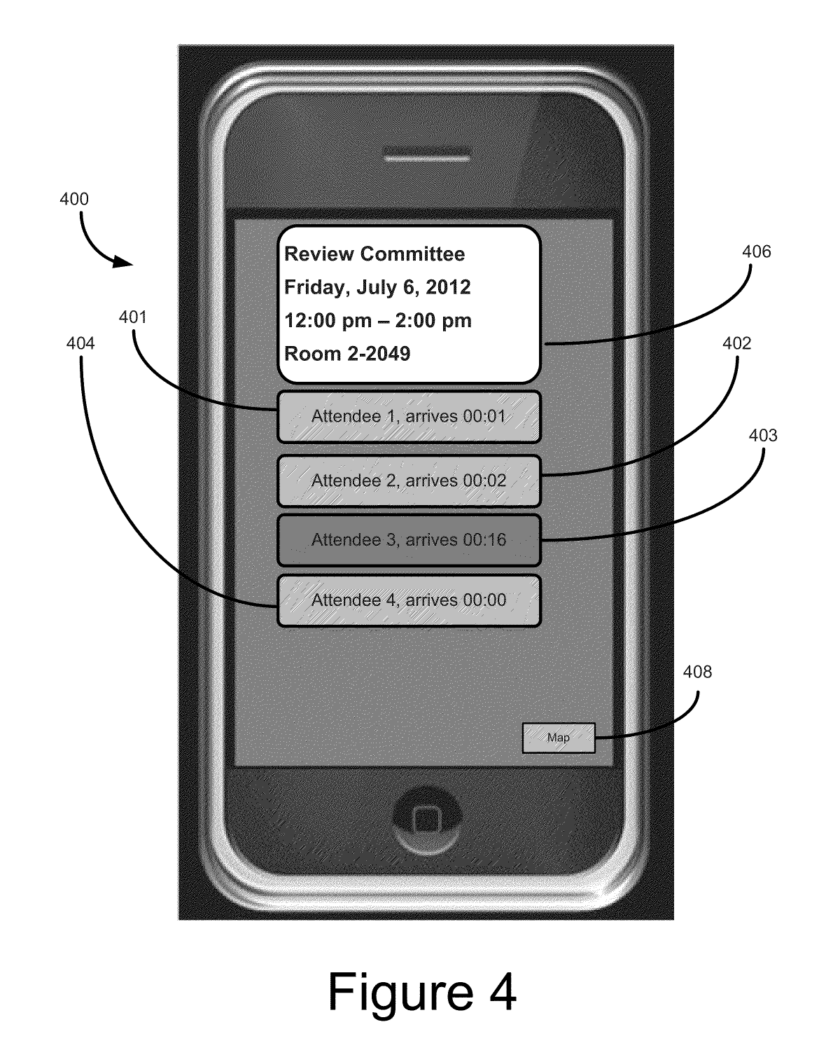

Appointment information, on time status, and appointment participant location information can be displayed in any number of ways, for example, as shown in FIG. 4. FIG. 4 illustrates one exemplary view of the user interface of a mobile device 400 displaying location aware appointment management application information. In this embodiment, color coded buttons can be provided for one or more appointment participants. As shown in FIG. 4, a separate attendee button is displayed for each appointment participant (four in the example shown here) 401, 402, 403, and 404. One color, such as green, can be used to designate that the appointment participant is on schedule to arrive on or before the scheduled appointment time 401, 402, and 404 and another color, such as red, can be used to designate that the appointment participant is scheduled to arrive late to the appointment 403. In other implementations, additional or different visual indications can be used to communicate status, including additional states and the use of different shapes, designs, and/or textures. In addition to color, the actual ETA of each appointment participant can be shown in the appointment participant buttons 401-404. Appointment information, such as the subject of the appointment, appointment date, time and location, can also be shown in an appointment information button 406. The user interface can present appointment information, appointment participant information and on-time status in many different ways and/or views. View buttons, such as button 408, can also be provided for switching between the various views. One or more of the buttons 401-408 can be activated by touching the button on a touch screen user interface to display more or different information or to switch to edit mode for the particular information.

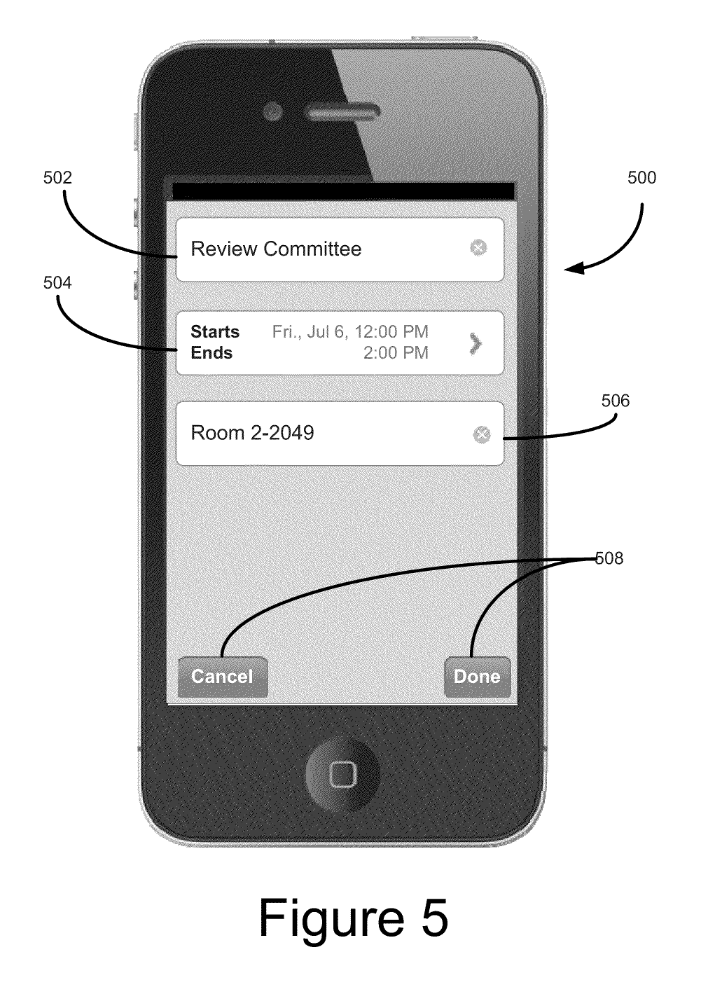

FIG. 5 illustrates a mobile device 500 displaying an exemplary appointment information edit screen which can be activated by, for example, selecting the appointment information button 406 in FIG. 4. As shown, the user interface displays information input boxes 502-506 for inputting and/or editing appointment information. The subject matter of the appointment can be entered, displayed, and/or edited in box 502. The appointment date, start time, and end time can be entered, displayed, and/or edited in box 504. The appointment location can be entered, displayed, and/or edited in box 506. In addition, done and cancel buttons 508 can be included to save (done) or cancel (cancel) any information entered and/or edited on the appointment information edit screen.

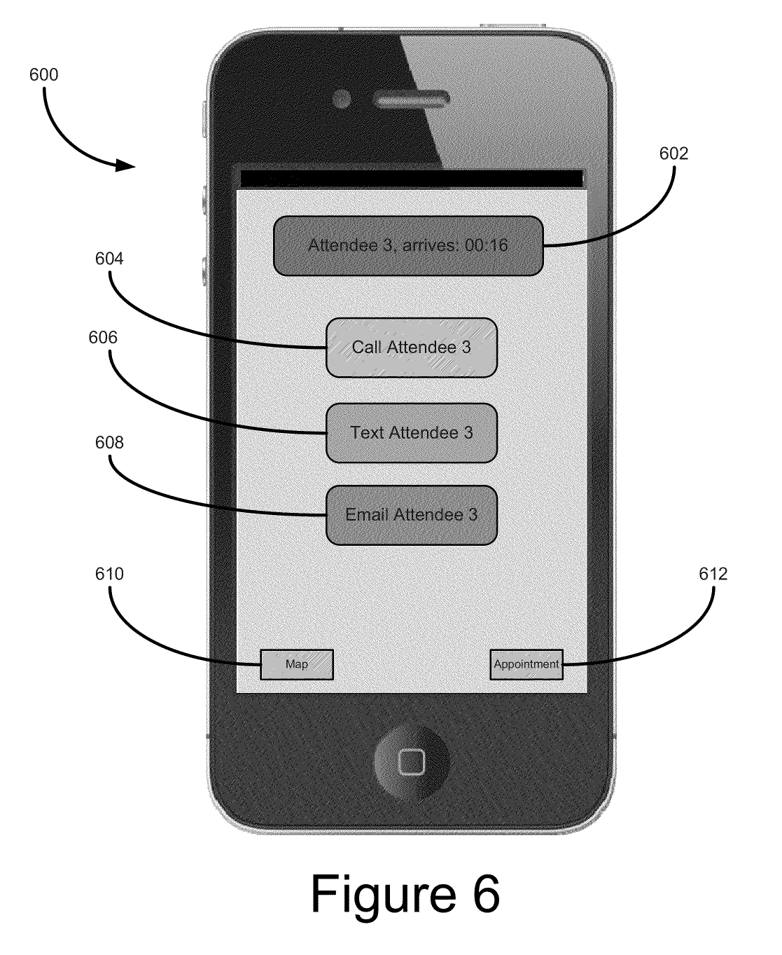

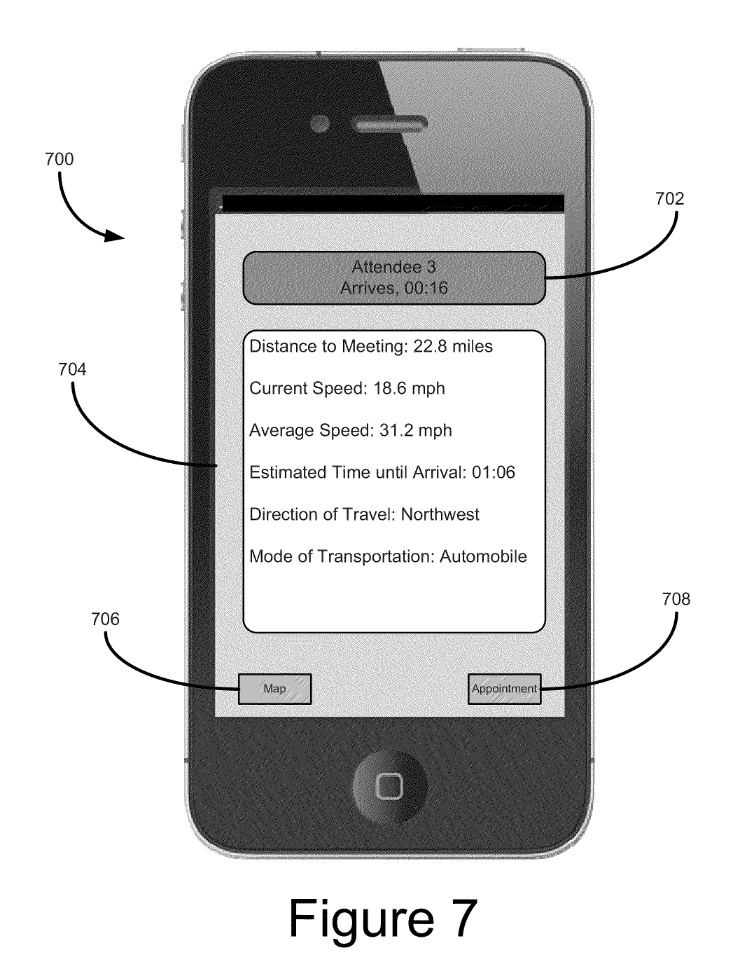

FIG. 6 illustrates a mobile device 600 displaying an exemplary appointment participant information screen which can be activated by, for example, selecting an appointment participant button such as button 403 in FIG. 4. As shown, the user interface can display the appointment participant on-time status information in a participant on-time status button 602 as well as provide buttons for various means of contacting the appointment participant 604-608. Separate buttons for calling 604, texting 606, and emailing 608 the appointment participant can be provided by the user interface. Selecting the call button 604 initiates a telephone call to the selected appointment attendee. Selecting the text button 606 can initiate an SMS application for sending a text message to the selected appointment attendee. Selecting the email button 608 can initiate an email application for sending an email to the appointment attendee. The phone number and preferred email address of the appointment participant can be stored by the location aware appointment management application so that phone call, text message, and/or email information can be pre-filled when selecting one of the contact buttons 604-608. Alternative view buttons 610 and 612 can also be included in this view by the user interface. For example, a map button 610 can be included for switching to a map view, exemplary embodiments of which are described in more detail below. An appointment button 612 can also be included for switching, for example, back to the appointment on-time status view shown in FIG. 4. One or more other buttons, such as the participant on-time status button 602 can also switch to, for example, a detailed participant status view such as shown in FIG. 7.

FIG. 7 illustrates one embodiment of a mobile device 700 displaying a detailed participant status view screen which can be activated by, for example, selecting a participant on-time status button, such as button 602 in FIG. 6. As shown, the user interface can display detailed appointment participant on-time status information on the detailed participant status view screen. This view can include, for example, an on-time status of the selected participant such as by displaying ETA in an on-time status window 702 and by using a color (such as red for estimated late arrival and green for estimated on-time arrival) to indicate whether the appointment participant is estimated to be on-time or late for the appointment. In other implementations, different or additional colors, icons, textures, and/or graphics can be used to convey information, such as ETA and status. In addition, detailed participant travel information can be displayed in a detailed travel information window 704. The detailed travel information can include, for example, the participant's distance to the meeting, current speed, average speed, estimated time of arrival, direction of travel, mode of transportation, etc. Alternative view buttons 706 and 708 can also be included in this view by the user interface. For example, a map button 706 can be included for switching to a map view, exemplary embodiments of which are described in more detail below. An appointment button 708 can also be included for switching, for example, back to the appointment on-time status view shown in FIG. 4.

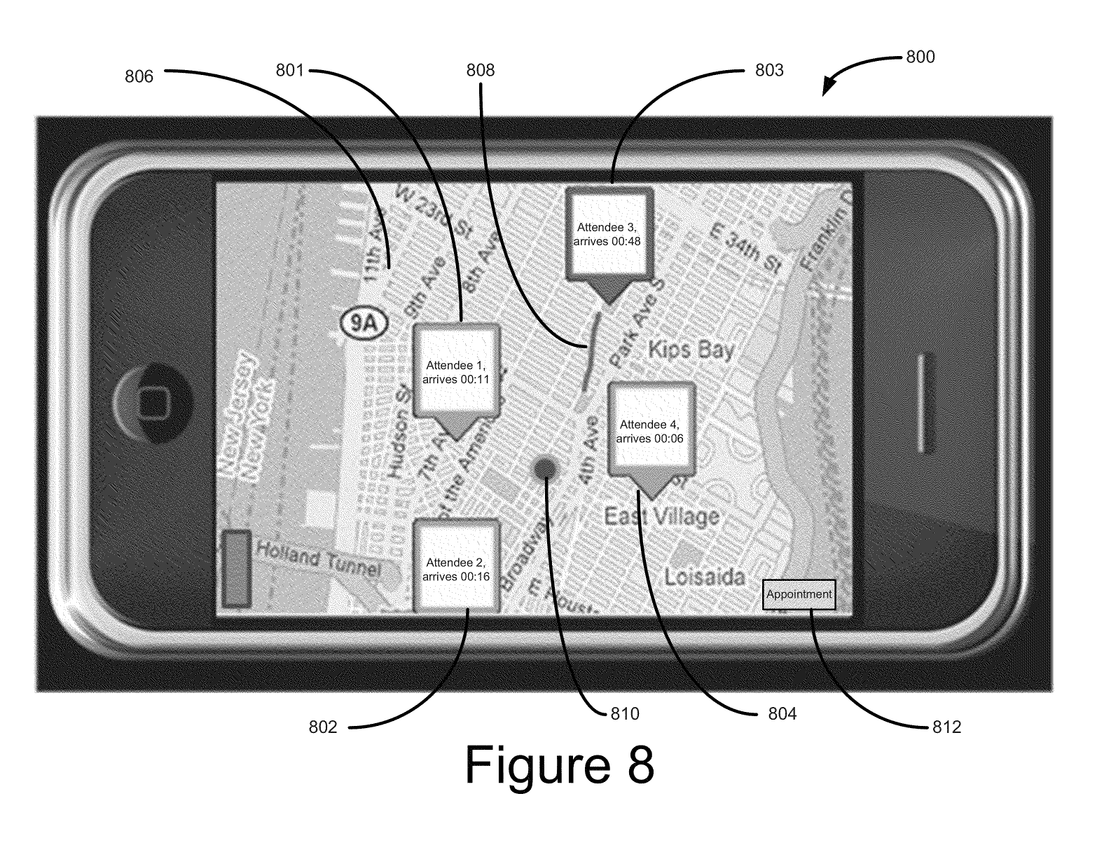

FIG. 8 illustrates a mobile device 800 displaying an exemplary map view screen activated by, for example, selecting a map button, such as button 408 in FIG. 4. As shown, in map view the user interface can display the appointment participant on-time status information in participant status boxes 801-804 superimposed on a map 806 with each participant status box 801-804 being superimposed on the map 806 in the estimated current location of the appointment participant. The estimated location of each appointment participant can be updated in real-time as they travel toward the appointment location 810 and the appointment location 810 can also be superimposed on the map 806. Real-time travel conditions 808, such as a traffic jam, can be displayed on the map along the expected travel route of any of the appointment participants. An appointment button 812 can also be included for switching, for example, back to the appointment on-time status view, such as the one shown in FIG. 4.

As shown in FIG. 8, the on-time status of each appointment participant can be displayed in the participant status boxes 801-804 in several ways. As in previously described exemplary embodiments, a color coded box can be provided to represent an appointment participant. A separate participant status box 801-804 can be displayed for each appointment participant. One color, such as green, can be used to designate that the appointment participant is on scheduled to arrive on or before the scheduled appointment time, such as participant status boxes 801, 802 and 804, and another color, such as red, can be used to designate that the appointment participant is scheduled to arrive late to the appointment, such as participant status box 803. In addition to color, the actual ETA of each appointment participant can be shown in the participant status boxes 801-804. Each of the participant status boxes 801-804 can act as a button which, when selected can bring up the selected participant's information screen, such as, for example, the one shown in FIG. 6. Color can also be used to indicate real-time travel conditions. For example, in the exemplary embodiment shown in FIG. 8, a red line 808 along the travel route of attendee 3 indicates that attendee 3 is expected to encounter slow travel conditions for a portion of his/her travel route. Other colors also can be used to indicate a travel condition, for example, a green line along the travel route of an attendee could be used to indicate that traffic is moving smoothly along the route and/or a yellow line could be used to indicate that traffic is moving, but at a rate slower than the speed limit or slower then would normally be expected along the route. Additionally, icons, textures, graphics, avatars, photos, and colors can be used to personalize the participant status boxes 801-804, augment the appointment location 810, and/or indicate relevant information, such as travel conditions, route information, and/or transportation options.

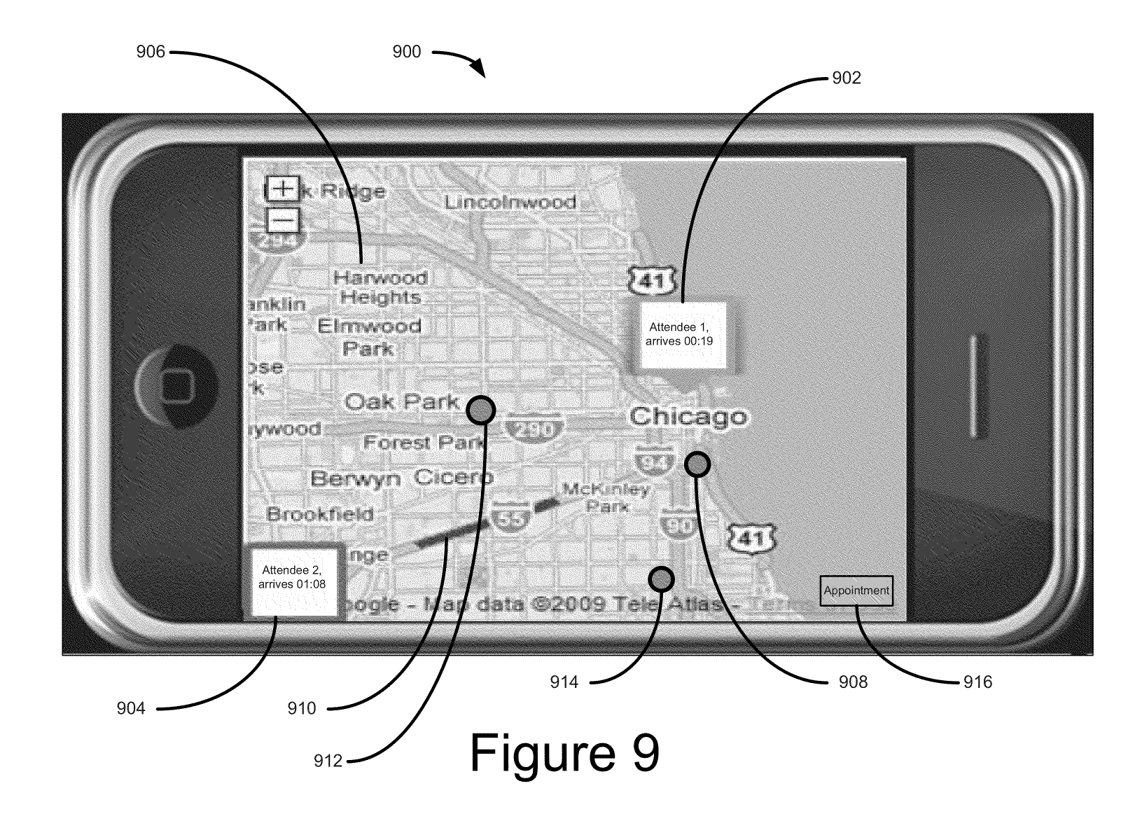

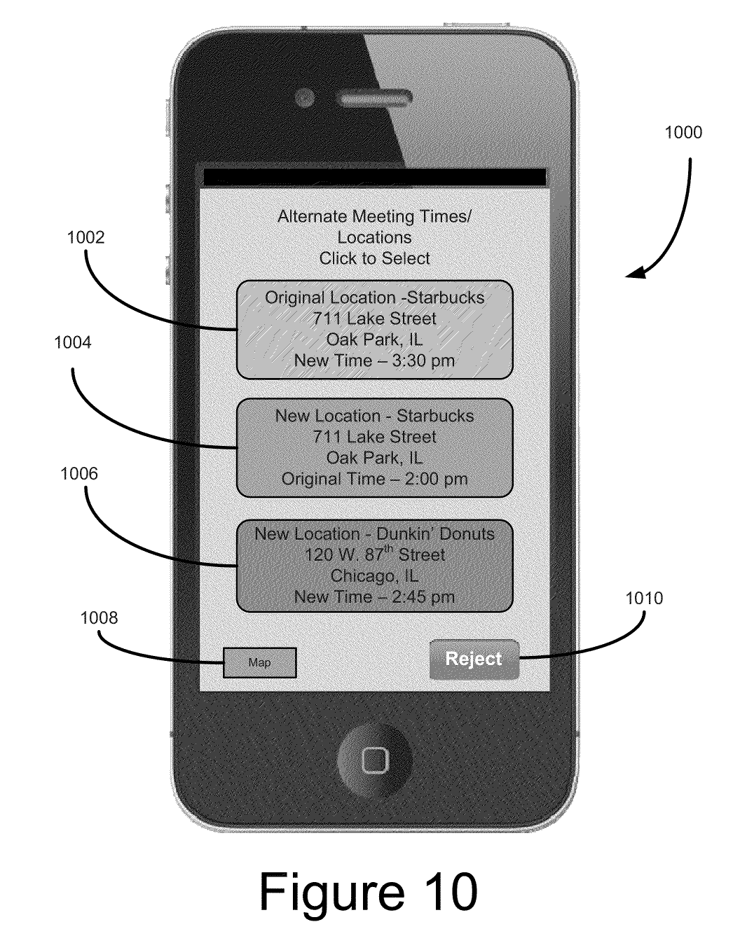

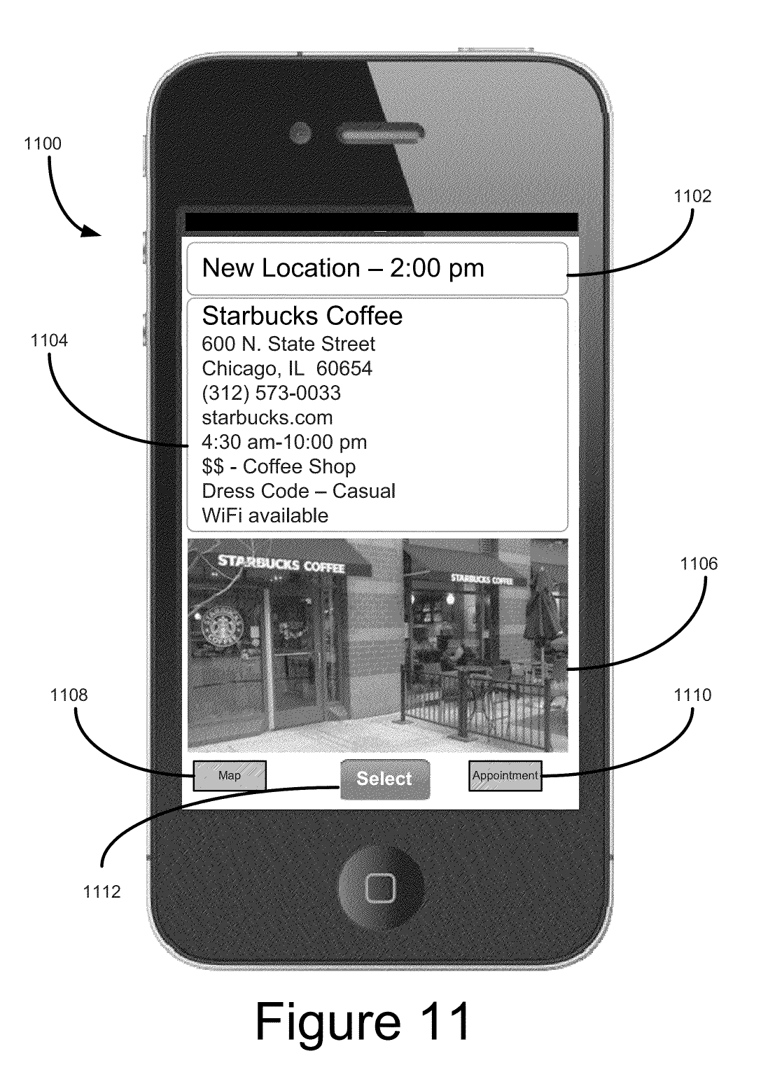

FIG. 9 illustrates a mobile device 900 displaying an exemplary map view screen showing alternative appointment locations suggested by the location aware appointment management application upon determining that at least one appointment participant is expected to be late for the appointment. As shown, in map view, the user interface can display the appointment participant on-time status information in a participant on-time status boxes 902, 904 superimposed on a map 906 with each appointment participant box 902, 904 being superimposed on the map 906 in the estimated current location of the appointment participant. The location of each appointment participant can be updated, e.g. in real-time as they travel toward the original appointment location. The appointment location can be indicated by an appointment location button 908 also superimposed on the map 906. Real-time travel conditions 910, such as a traffic jam, can be displayed on the map along the expected travel route of any of the appointment participants. In addition to the original appointment location button 908, the map view can display one or more alternative appointment locations. The exemplary map view of FIG. 9 shows two alternative appointment locations at which the location aware appointment management application predicts all appointment participants to arrive at the designating appointment time. The alternative appointment locations can be indicated by alternative appointment location buttons 912, 914 superimposed on the map 906. The appointment location button 908 and alternative appointment location buttons 912, 914, can include text and/or graphics to convey information about the location, such as a logo of a store or restaurant or an indication of the resources and/or types of service available there. Selecting any one of the location appointment buttons 908, 912, 914 can cause the user interface to display a location details view, such as the one described in more detail below with reference to FIG. 11. The user interface can also include an appointment button 916 for switching to an alternative suggested appointment location view, such as the one described in more detail below with reference to FIG. 10.

As shown in FIG. 9, the on-time status of each appointment participant can be displayed in the participant on-time status boxes 902, 904 in several ways. As in previously described exemplary embodiments, color coded boxes can be provided for each appointment participant. A separate participant on-time status box can be displayed for each appointment participant 902, 904. One color, such as green, can be used to designate that the appointment participant is on schedule to arrive on or before the scheduled appointment time 902 and another color, such as red, can be used to designate that the appointment participant is scheduled to arrive late to the appointment 904. In addition to color, the actual ETA of each appointment participant can be shown in the participant on-time status boxes 902, 904. Each of the participant on-time status boxes 902, 904 can act as a button which, when selected can bring up the selected participant's information screen, such as, for example, the one shown and described in FIG. 6. Color can also be used to indicate real-time travel conditions. For example, in the exemplary embodiment shown in FIG. 9, a red line along the travel route of attendee 2 indicates that attendee 2 is expected to encounter slow traffic for a portion of his/her travel route. While not specifically shown in FIG. 9, a green line along the travel route of an attendee could be used to indicate that traffic is moving smoothly along the route and/or a yellow line could be used to indicate that traffic is moving, but at a rate slower than the speed limit or slower then would normally be expected along the route. Additionally, icons, textures, graphics, avatars, photos, and colors can be used to personalize the participant status boxes 902 and 904, augment the appointment locations 908, 912, and 914, and/or indicate relevant information, such as travel conditions, route information, and/or transportation options.

FIG. 10 illustrates a mobile device 1000 displaying an exemplary appointment location summary view screen showing alternative appointment locations suggested by the location aware appointment management application upon determining that at least one appointment participant is expected to be late for the appointment. As shown in FIG. 10, a list of possible appointment locations including the original appointment location and alternative appointment locations suggested by the location aware appointment management application can be displayed in the appointment location summary view. Each location can be represented by an appointment location summary button 1002, 1004, and 1006. The original appointment location button 1002, can show the name and address of the original appointment location as well as a new proposed appointment time at which all appointment participants are predicated to arrive at the original appointment location. The new, alternative appointment locations suggested by the location aware appointment management application are also represented by appointment location buttons 1004, 1006.

The location aware appointment management application can consider any number of factors in determining which alternative locations to suggest. In the embodiment illustrated in FIG. 10, the location aware appointment management application suggests includes two alternative locations, one in which all appointment participants can meet at the original appointment time (represented by appointment location button 1004) and another, closer to the original appointment location at which all appointment participants can meet at a time after the original appointment location but before the time it is predicted all appointment participants can arrive at the original appointment location (represented by location appointment button 1006). Selecting any one of the location appointment buttons 1002, 1004, 1006 can cause the user interface to display a location details view, such as the one described in more detail below with reference to FIG. 11. A map button 1008 can also be included for switching to a map view such as the one shown and described in reference to FIG. 9. A reject button 1010 can also be included for allowing the appointment participants to reject the proposed alternative appointment arrangements and keep the currently scheduled appointment.

FIG. 11 illustrates a mobile device 1100 displaying an exemplary appointment location detail view screen showing a selected appointment location. As shown in FIG. 11, an appointment time as well as appointment location details are listed in this view. The appointment time is the time 1102 generated by the location aware appointment management application calculated to be when all appointment participants can arrive at the appointment location. The appointment details 1104 can include a description of the appointment location, an appointment location address, an appointment location phone number, an appointment location website, the hours of operation of the appointment location, the type of and estimated cost of the appointment location, the dress code (if any) of the appointment location, available resources at the appointment location (such as Wi-Fi access), etc. A photograph of the appointment location 1106 can also be included in the appointment location details. A map button 1108 can be included for switching back to a map view such as the one shown and described with reference to FIG. 9 and an appointment button 1110 can be included for switching back to an appointment summary view such as the one shown and described with reference to FIG. 10. A select button 1112 can also be included for allowing the appointment participants to select the new appointment location and/or time. As described in further detail herein, if an alternative appointment location and/or time is selected, the location aware appointment management application can make all of the necessary arrangements for securing the appointment location and required services and resources.

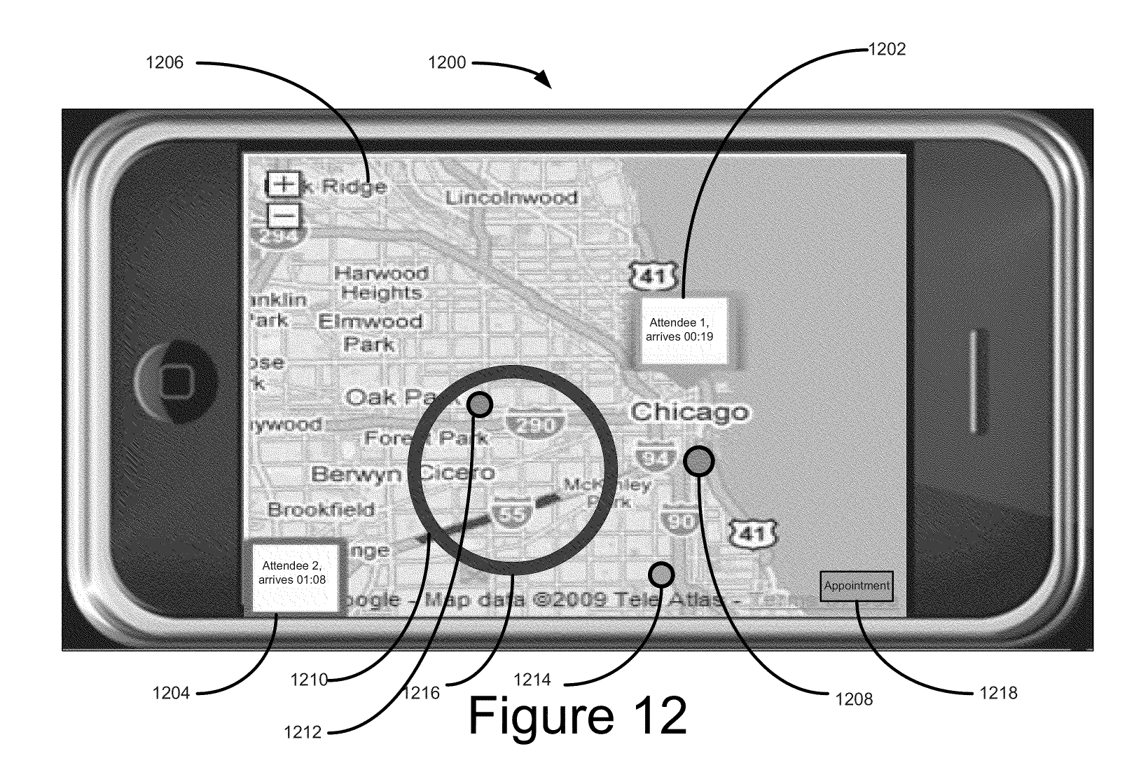

FIG. 12 illustrates a mobile device 1200 displaying an exemplary alternative map view screen showing alternative appointment locations suggested by the location aware appointment management application upon determining that at least one appointment participant is expected to be late for the appointment. As shown, in map view, the user interface can display the appointment participant on-time status information in participant on-time status boxes 1202, 1204 superimposed on a map 1206 with each appointment participant box 1202, 1204 being superimposed on the map 1206 in the estimated current location of the appointment participant. The estimated location of an appointment participant can be updated, e.g. in real-time as they travel toward the original appointment location. The appointment location can be indicated by an appointment location button 1208 also superimposed on the map 1206. Real-time travel conditions 1210, such as a traffic jam, can be displayed on the map along the expected travel route of any of the appointment participants. Additionally, icons, textures, graphics, avatars, photos, and colors can be used to personalize the participant status boxes 1202 and 1204, augment the appointment locations 1208, 1212, and 1214, and/or indicate relevant information, such as travel conditions, route information, and/or transportation options.

In addition to the original appointment location button 1208, this map view shows two alternative appointment locations at which the location aware appointment management application predicts all appointment participants to arrive at the designating appointment time. The alternative appointment locations can be indicated by alternative appointment location buttons 1212, 1214 superimposed on the map 1206. Selecting any one of the location appointment buttons 1208, 1212, 1214 can cause the user interface to display a location details view as described in more detail above with reference to FIG. 11. The user interface can also include an appointment button 1218 for switching to an alternative suggested appointment location view, such as the one described in more detail above with reference to FIG. 10. A circle of convergence 1216 can also be displayed superimposed on the map 1206. The circle of convergence 1216 can show, on the map 1206, the area in which the location aware appointment management application estimates that all appointment participants will be able to arrive by the original appointment time. The circle of convergence 1216 could be used by the appointment participants to select an alternative appointment location in which all of the appointment participants can arrive by the original appointment time. One or more of the appointment participants familiar with the area may have alternative appointment location suggestions, based on the circle of convergence 1216, not suggested by the location aware appointment management application. If so, the appointment participant could send out a group SMS or other message to the other appointment participants suggesting the alternative appointment location. If it is agreed among the appointment participants to choose the proposed alternative appointment location, the location aware appointment management application can make all necessary arrangement to secure the appointment location and the required services and resources.

Exemplary embodiments of location aware appointment management applications according to the present disclosure can be applied to a variety of appointment types. For example: business meetings, personal meetings, group dinners, happy hour gatherings, group movie gatherings, restaurant reservations, etc. Embodiments of the disclosure can also be used by a variety of different users. For example, a group of people making a reservation to have dinner together at a restaurant might use the location aware appointment management application to track each other and to determine that everyone is going to make the reservation on time. A restaurant might also use the location aware appointment management application it to track its diners. For example, if the restaurant is busy and it appears that one person in a group is going to be late, the restaurant may offer to delay the group's reservation so that it can seat another group waiting for a table. Embodiments of the location aware appointment management application might be used by an airline to track whether its passengers are going to be on-time for a scheduled flight and, if not, offer a guaranteed seat on a later flight so that the airline can accommodate stand by passengers on the original flight. Medical offices could use embodiments of the location aware appointment management application to track whether patients are going to be on time for appointments. Schools and/or employers could track students and/or employees to determine whether they are going to be on-time for school and/or work. As is readily apparent, there are multiple various applications for embodiments of the location aware appointment management application disclosed herein.

Additional features can also be added to embodiments of the location aware appointment management application. For example, since the estimated location of appointment participants is known and tracked, location-based advertisements can be broadcast to the appointment participants advertising goods and/or services near the appointment participants' locations or along their predicted route to the appointment location. Reminders on when to leave based on the expected time it will take to get to an appointment location by the scheduled appointment time can be broadcast to the appointment participants, the reminders taking into consideration the factors discussed herein for determining the ETA of each appointment participant to an appointment location. The ability for an appointment participant to indicate to others that “I might be late” or for a medical office or restaurant to indicate that reservations and/or appointments are running behind can also be included in the location aware appointment management application.

It should be noted that the present disclosure includes various diagrams that may depict an example architectural or other configuration for the various embodiments, which is done to aid in understanding the features and functionality that can be included in embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the terms “example” or “exemplary” are used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module can describe a given unit of functionality that can be performed in accordance with one or more embodiments. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. Where components or modules of the disclosure are implemented in whole or in part using software, in one embodiment, these software elements can be implemented to operate with a computing or processing module capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A location aware appointment management application embodied on a non-transitory computer-readable medium, the application comprising computer code adapted to:
obtain information associated with an appointment, the information comprising appointment date, appointment time, appointment location, and at least one appointment participant;
determine the location of the at least one appointment participant; and
calculate an estimated time of arrival at the appointment location of the at least one appointment participant based at least in part on the determined location of the at least one appointment participant and appointment specific predictive information regarding the appointment.

2. The application of claim 1 further comprising computer code adapted to collect user specific predictive information about at least one appointment participant's travel habits.

3. The application of claim 1 further comprising computer code adapted to collect route specific predictive information about a route of travel of the at least one appointment participant.

4. The application of claim 1 wherein the appointment specific predictive information further comprises user specific predictive information regarding the at least one appointment participant's travel habits.

5. The application of claim 1 wherein the appointment specific predictive information further comprises route specific predictive information regarding the at least one appointment participant's travel route to the appointment location.

6. The location aware appointment management application of claim 1, further comprising computer code adapted to:
estimate, based at least in part on the estimated time of arrival of the at least one appointment participant, that the at least one appointment participant will arrive at the appointment location after the appointment time; and
determine, responsive to estimating, an alternate appointment arrangement at which it is estimated that the at least one participant can arrive on-time.

7. The application of claim 6 wherein the alternative appointment arrangement further comprises an alternative appointment location.

8. The application of claim 6 wherein the alternative appointment arrangement further comprises an alternative appointment time.

9. A mobile device comprising:
a location based services module configured to determine a location of the mobile device; and
a location tracking application stored in a computer readable medium, the application configured to:
obtain appointment information comprising appointment date, appointment time, appointment location and another appointment participant;
estimate a time of arrival of the mobile device at the appointment location; and
determine when the mobile device is estimated to arrive late for the appointment based at least in part on the estimated time of arrival and the appointment time; and
responsive to determining that the mobile device is estimated to arrive late for the appointment, determining an alternate appointment arrangement at which it is estimated that the mobile device and the another appointment participant can arrive on-time.

10. The device of claim 9 wherein the alternative appointment arrangement further comprises an alternative appointment location.

11. The device of claim 9 wherein the alternative appointment arrangement further comprises an alternative appointment time.

12. The device of claim 9 wherein calculating an estimated time of arrival of the mobile device is further based on appointment specific predictive information regarding a user of the mobile device.

13. The device of claim 12 wherein the appointment specific predictive information further comprises user specific predictive information regarding the user's travel habits.

14. The device of claim 12 wherein the appointment specific predictive information further comprises route specific predictive information regarding the user's travel routes to the appointment location.

15. The device of claim 12 wherein determining the alternative appointment arrangement further comprises determining a plurality of alternative appointment arrangements and presenting the plurality of alternative appointment arrangements on a display of the device.

16. The device of claim 15 further comprising receiving a selection of one of the plurality of alternative appointment arrangements and setting the appointment information to correspond to the selected alternative appointment arrangement.

17. A location aware appointment management application embodied on a non-transitory computer-readable medium, the application comprising computer code adapted to:
obtain appointment information, the appointment information comprising appointment date, appointment time, appointment location, and a plurality of appointment participants;
determine a location for at least some of the plurality of appointment participants;
collect user specific predictive information about at least some of the plurality of appointment participants' travel habits;
calculate an estimated time of arrival of at least some of the plurality of appointment participants based at least in part on the determined location of the plurality of appointment participants, the appointment location, and the collected specific predictive information;
determine when at least one of the plurality of appointment participants is estimated to arrive late for the appointment based at least in part on the estimated time of arrival and the appointment time; and
responsive to determining that at least one of the plurality of appointment participants is estimated to arrive late for the appointment, determine alternate appointment information for which it is estimated that the plurality of appointment participants will arrive on time, display the determined alternative appointment information, receive an input from the plurality of appointment participants selecting the displayed alternative appointment information, and make alternative appointment arrangements based on the selected alternative appointment information.

18. The application of claim 17 further adapted to collect route specific predictive information about a route of travel of at least one of the plurality of appointment participants.

19. The application of claim 17 wherein making alternative appointment arrangements further comprises making a reservation at an alternative meeting location.

20. The application of claim 17 further adapted to send a reminder to at least one of the plurality of appointment participants indicating a time at which the appointment participant should leave his/her current location and start traveling to the appointment location in order to be on time for the appointment.
